(19) United States
(12) Patent Application Publication
(10) Pub. No.: US 2026/0243221 A1
(43) Pub. Date: Aug. 20, 2026

(54) ENGINE STARTER

(71) Applicant: Chaoting Lei, Chongqing (CN)

(72) Inventor: Chaoting Lei, Chongqing (CN)

(21) Appl. No.: 19/644,561

(22) Filed: Apr. 10, 2026

(51) Int. Cl. F02N 3/04

(52) U.S. Cl. CPC F02N 3/04

(57) ABSTRACT

Provided is an engine starter, which includes a shell, a unidirectional drive structure that includes an output wheel and an input wheel, the output wheel is rotatably provided on the shell, and the input wheel is connected to a crankshaft of an engine, the output wheel is connected to an output claw, and the input wheel is provided with an input slot; and a pedal drive structure that includes sector gear, a transmission gear, and a footstock lever. The sector gear are rotatably provided on the shell, and the transmission gear is rotatably provided on the shell and is connected to the output wheel. The sector gear mesh with the transmission gear, and the footstock lever is connected to the sector gear. This application has the effect of enabling the starter to meet the user’s starting requirements for the engine.

### TECHNICAL FIELD

The present disclosure relates to the field of starter technologies, and in particular, to an engine starter.

### BACKGROUND

The engine starter is the core component of the starting system, responsible for coordinating the conversion of electrical or kinetic energy to mechanical energy and ensuring the transition of the engine from a stationary state to automatic operation. There are various ways to start small engines, one of which is to use a rope type starter. By quickly pulling the rope, the starter drives the crankshaft of the engine to rotate, thereby achieving ignition and starting of the engine. This type of engine is usually used as a power source for low-cost small displacement equipment such as chainsaws. When this type of engine is applied to small cars and other vehicles as a power source for driving two vehicle carriers, the starter drives the crankshaft of the engine to rotate by quickly pulling the rope, which is difficult to meet the user’s starting needs for the engine. Therefore, it is necessary to improve the applicability of the starter. So that when the above-mentioned engine is applied to fields such as vehicle, the starter can meet the user’s starting needs for the engine.

### SUMMARY

In order to enable the starter to meet the user’s starting needs for the engine, this application provides an engine starter.

The engine starter provided in this application adopts the following technical solution.

An engine starter, including: a shell; a unidirectional drive structure, which includes an output wheel and an input wheel, where the output wheel is rotatably provided on the shell, the input wheel is connected to a crankshaft of an engine, the output wheel is connected to an output claw, the input wheel is provided with an input slot, and the output wheel has forward and reverse rotation; when the output wheel rotates in a forward direction, the output claw is opened in a direction away from the output wheel and penetrates the input slot to drive the input wheel to rotate; when the output wheel rotates in a reverse direction, the output claw is closed in a direction close to the output wheel and disengages from the input slot; and a pedal driving structure, which includes sector gear, a transmission gear, and a footstock lever; the sector gear are rotatably provided on the shell, and the transmission gear is rotatably provided on the shell and connected to the output wheel; the sector gear meshes with the transmission gear, and the footstock lever and sector gear are connected and configured to drive the sector gear to rotate.

In some embodiments of the present disclosure, the output wheel is provided with a connection hole, the connection hole extends from the output wheel to the transmission gear, and the connection hole is provided with a connection rod to achieve a connection between the transmission gear and the output wheel.

In some embodiments of the present disclosure, the output wheel includes a wheel body part, a first abutting part, and a second abutting part, the wheel body part and the first abutting part are integrally formed, and the second abutting part is connected to the first abutting part; when the connection rod is provided in the connection hole, the connection rod sequentially connects the wheel body part, the first abutting part, and the second abutting part to achieve a connection between the first abutting part and the second abutting part.

In some embodiments of the present disclosure, a protective plate is provided between the transmission gear and the output wheel, the protective plate is configured to protect the output wheel, and when the protective plate is provided between the transmission gear and the output wheel, the connection rod passes through the protective plate to achieve a connection between the transmission gear, the protective plate, and the output wheel.

In some embodiments of the present disclosure, the unidirectional drive structure further includes an opening plate, and the opening plate is rotatably provided on the shell, the opening plate is provided with an opening protrusion; when the output wheel rotates in the forward direction, the opening protrusion pushes the output claw to open in a direction away from the output wheel.

In some embodiments of the present disclosure, an opening spring is provided between the opening plate and the output wheel, one end of the opening spring is in contact with the opening plate, and the other end of the opening spring is in contact with the output wheel.

In some embodiments of the present disclosure, the output claw is fixedly provided with a connection protrusion, the output wheel is provided with a connection recess, the connection protrusion is penetrated through the connection recess, and the output claw abuts against the opening plate to achieve a connection between the output claw and the output wheel.

In some embodiments of the present disclosure, an output torsion spring is provided between the output claw and the output wheel, and the output torsion spring is configured to push the output claw to be closed in a direction close to the output wheel.

In some embodiments of the present disclosure, the pedal driving structure further includes a reset torsion spring, one end of the reset torsion spring is connected to the sector gear, and the other end of reset torsion spring is connected to the shell.

In some embodiments of the present disclosure, the footstock lever includes a fixed portion and a lever body, the fixed portion is connected to the sector gear, and the lever body is rotatably connected to the fixed portion.

In summary, this application includes at least one beneficial technical effect as follows.

When the engine needs to be started, the user quickly steps on the pedal, which drives the sector gear to rotate, and the sector gear drive the transmission gear to rotate. The transmission gear drives the output wheel to rotate in the forward direction, so that the output claw opens in the direction away from the output wheel and passes through the input slot to drive the input wheel to rotate, thereby driving the crankshaft of the engine to rotate and start the engine. By quickly stepping on the pedal to drive the engine, it can better meet the user’s starting needs for the engine as a power source for cars and other vehicles, and improve the problem that the starter drives the engine to rotate by quickly pulling the rope, which is difficult to adapt to the user’s starting needs for the engine, besides that, after the engine is started, the output wheel rotates in the opposite direction, and the output claw closes in the direction close to the output wheel and disengages from the input slot, thereby achieving one-way power transmission between the output wheel and the input wheel.

### BRIEF DESCRIPTION OF DRAWINGS

FIG. 1 is a first schematic diagram of an overall structure of an embodiment of the present application.

FIG. 2 is a second schematic diagram of the overall structure of an embodiment of the present application.

FIG. 3 is a schematic diagram of a unidirectional drive structure of an embodiment of the present application.

FIG. 4 is a sectional view of the overall structure of an embodiment of the present application.

FIG. 5 is a schematic diagram of a pedal driving structure in an embodiment of the present application.

FIG. 6 is a schematic structural diagram of an output wheel in an embodiment of the present application.

FIG. 7 is a sectional structural view of the output wheel in an embodiment of the present application.

FIG. 8 is a schematic structural diagram of an output claw in an embodiment of the present application.

Numeral reference: 1- shell; 11- rotating shaft; 2- unidirectional drive structure; 21- output wheel; 211- output claw; 2111- connection protrusion; 2112- output torsion spring; 212- connection hole; 2121- connection rod; 213- rotating hole; 214- connection recess; 21a- wheel body part; 21b- first abutting part; 21c- second abutting part; 22- input wheel; 221- input slot; 23- protective plate; 24- opening plate; 241- opening protrusion; 242- opening spring; 3- pedal driving structure; 31- sector gear; 32- transmission gear; 33- footstock lever; 331- fixed portion; 332- lever body; 34- reset torsion spring.

### DESCRIPTION OF EMBODIMENTS

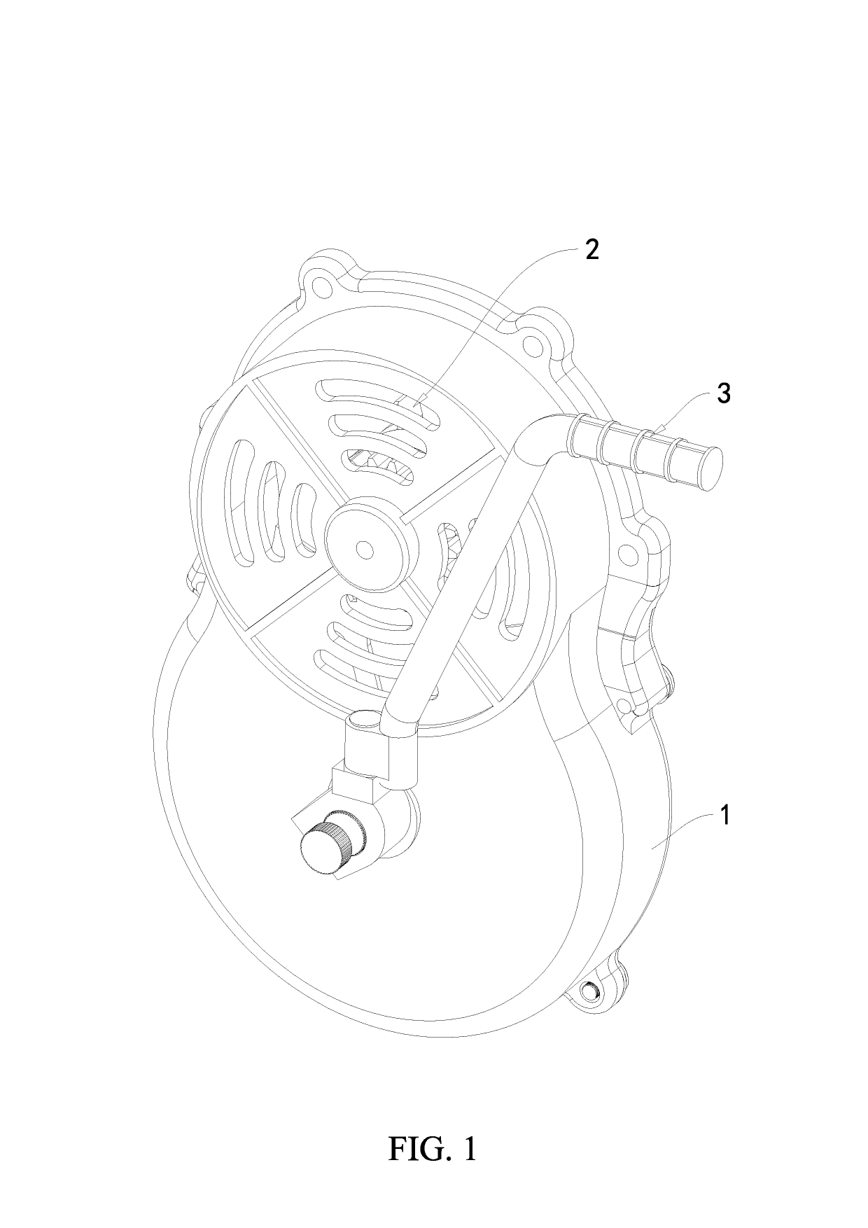

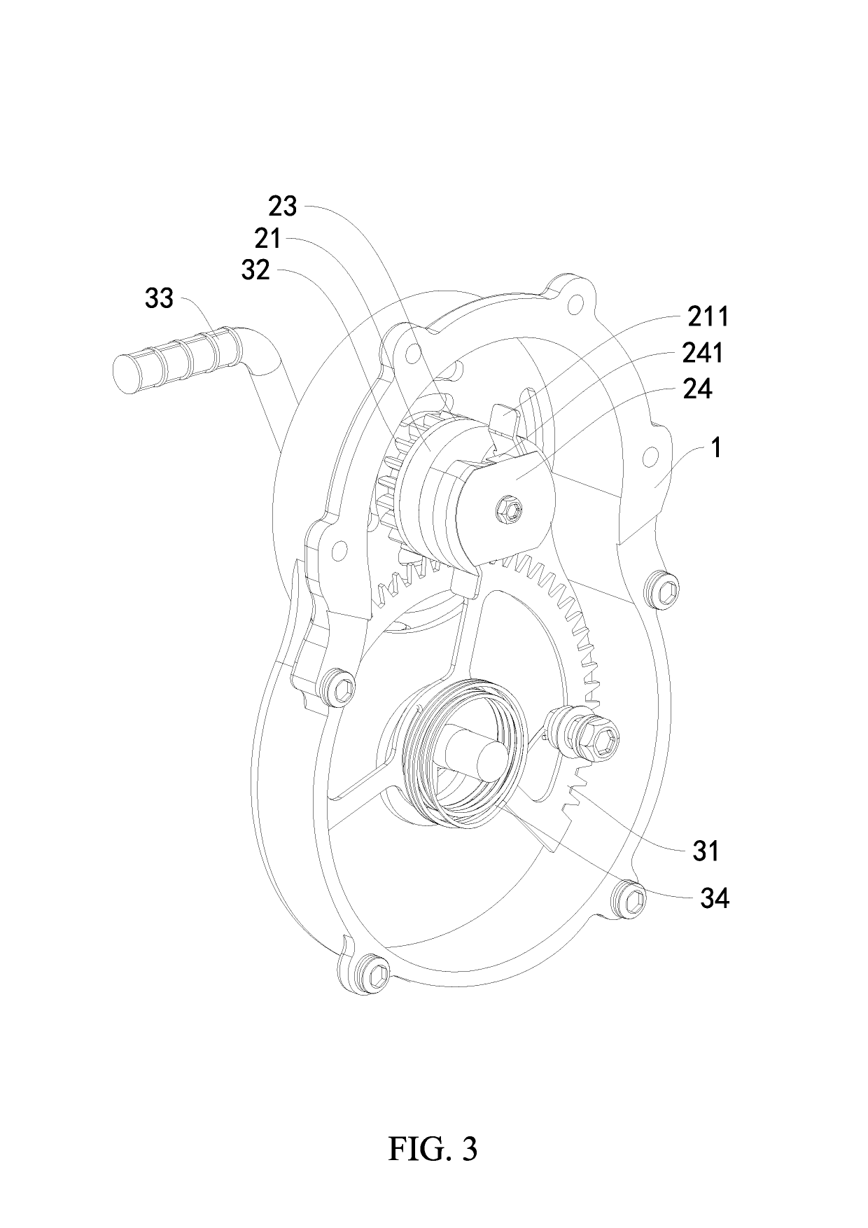

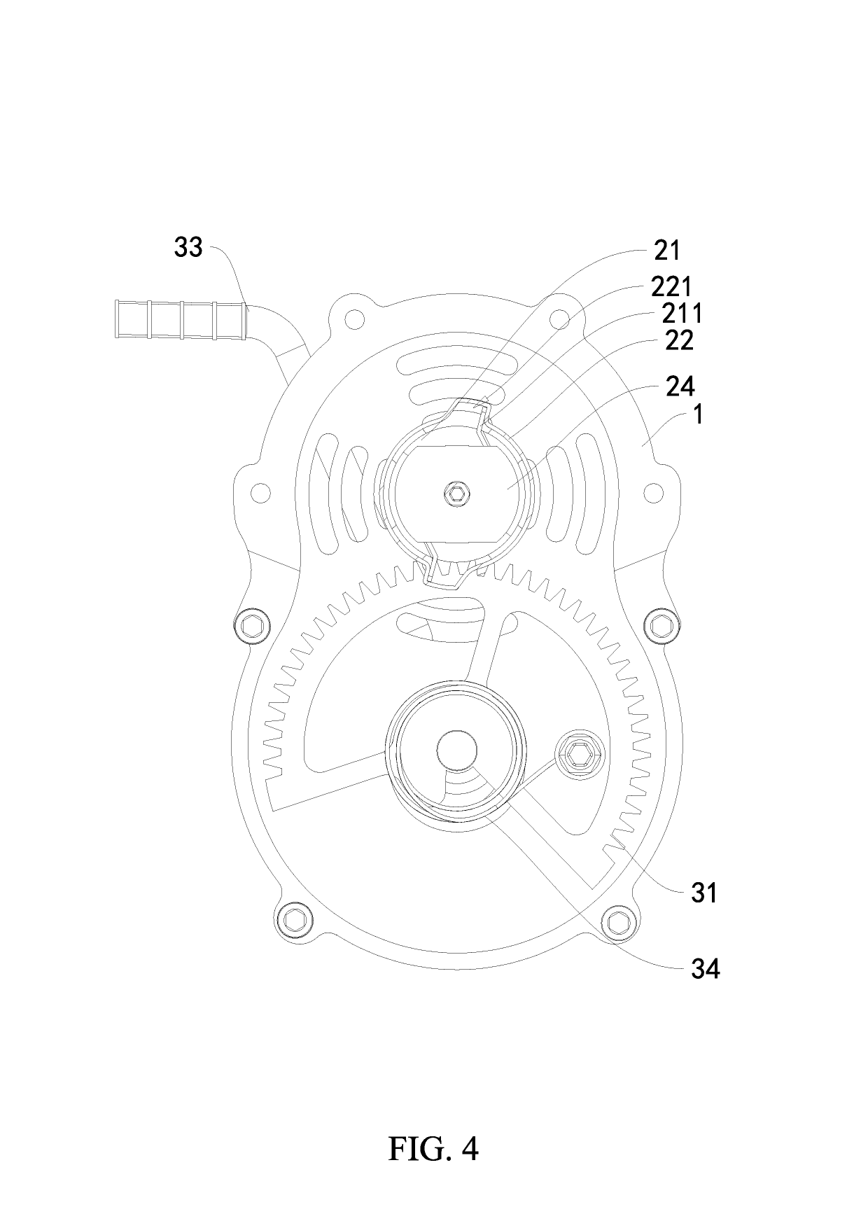

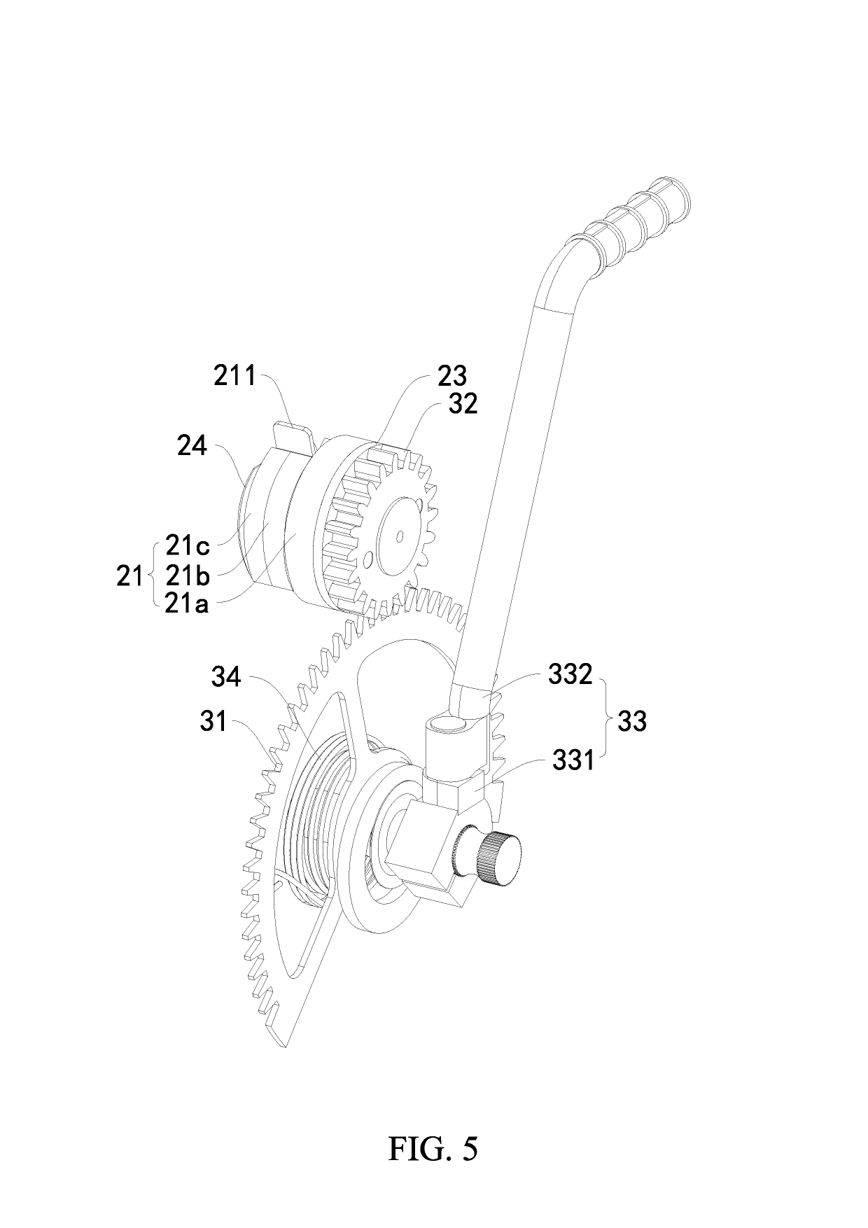

Further detailed explanations of the present application will be provided in combination with FIGS. 1 to 8.

The embodiment of the present application discloses an engine starter. Referring to FIGS. 1 to 5, the engine starter includes a shell 1, a unidirectional drive structure 2, and a pedal driving structure 3. The unidirectional drive structure 2 includes an output wheel 21 and an input wheel 22. The output wheel 21 is rotatably provided on the shell 1, and the input wheel 22 is connected to a crankshaft of an engine. The output wheel 21 is connected to an output claw 211, and the input wheel 22 is provided with an input slot 221. The output wheel 21 has a forward rotation and a reverse rotation in an opposite direction to the forward rotation. When the output wheel 21 rotates in the forward direction, the output claw 211 opens in a direction away from the output wheel 21 and penetrates the input slot 221 to drive the input wheel 22 to rotate. When the output wheel 21 rotates in the reverse direction, the output claw 211 closes in a direction close to the output wheel 21 and disengages from the input slot 221. The pedal driving structure 3 includes sector gear 31, a transmission gear 32, and a footstock lever 33. The sector gear 31 is rotatably provided on the shell 1, The transmission gear 32 is rotatably provided in the shell 1, and connected to the output wheel 21. The sector gear 31 mesh with the transmission gear 32, and the footstock lever 33 is connected to the sector gear 31 and configured to drive the sector gear 31 to rotate.

It should be understood that the forward and reverse rotations of the output wheel 21 are based on the input wheel 22 as a reference. Specifically, assuming the crankshaft of the engine drives the output wheel 21 to rotate, an angular velocity of a rotation in the same direction as the output wheel 21 is positive, and an angular velocity of a rotation in the opposite direction to the output wheel 21 is negative. Therefore, when the angular velocity of the output wheel 21 is greater than that of the input wheel 22, the output wheel 21 rotates in the forward direction. When the angular velocity of the output wheel 21 is less than that of the input wheel 22, the output wheel 21 rotates in the reverse direction. Therefore, after the engine is started, the angular velocity of the input wheel 22 driven by the crankshaft of the engine is greater than that of the output wheel 2, the input wheel 22 will push the output claw 211 to close in a direction close to the output wheel 21 and disengage from the input slot 221, thereby cutting off a power transmission between the output wheel 21 and the input wheel 22, rendering the power transmission between the output wheel 21 and the input wheel 22 to be unidirectional.

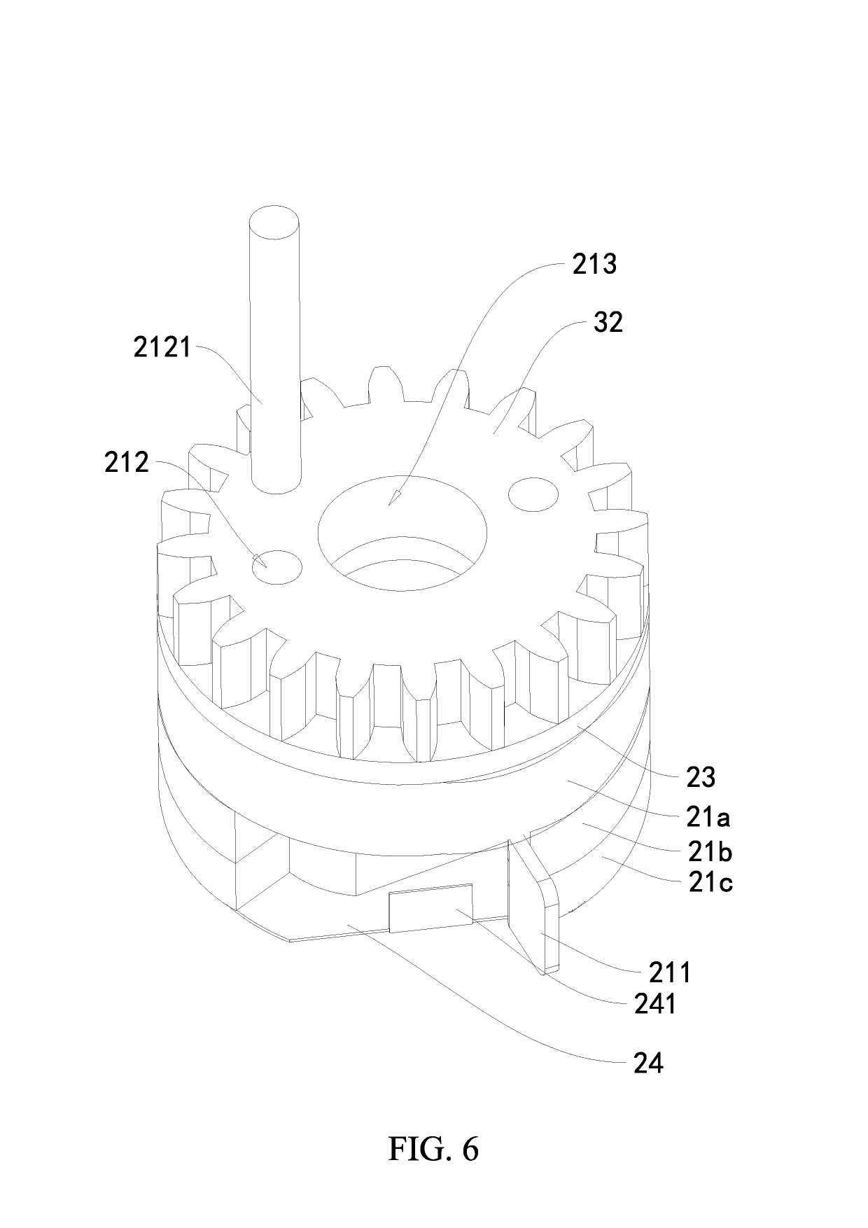

Referring to FIG. 6, in the embodiment of the present application, the output wheel 21 is provided with a connection hole 212, and the connection hole 212 extends from the output wheel 21 to the transmission gear 32. The connection hole 212 is provided with a connection rod 2121 to achieve a connection between the transmission gear 32 and the output wheel 21, so that when the transmission gear 32 rotates, the transmission gear 32 and the output wheel 21 rotate synchronously. It can be understood that the number of the connection rods 2121 can be one or more, which is not limited by the present application. Besides that, it can be understood that when the connection rod 2121 is penetrated through the connection hole 212, the connection rod 2121 cannot disengage from the connection hole 212. The stable setting of the connection rod 2121 in the connection hole 212 can be achieved through dimensions at two ends of the connection rod 2121 being larger than the connection hole 212, and adhesive can also be used to fix the connection rod 2121 to the connection hole 212. This application does not limit this.

Referring to FIG. 6, in an implementation mode, the output wheel 21 includes a wheel body part 21a, a first abutting part 21b, and a second abutting part 21c. The output wheel 21 and the first abutting part 21b are integrally formed, and the second abutting part 21c is connected to the first abutting part 21b. When the connection rod 2121 is provided in the connection hole 212, the connection rod 2121 sequentially connects the wheel body part 21a, the first abutting part 21b, and the second abutting part 21c to achieve a connection between the first abutting part 21b and the second abutting part 21c. It should be understood that the structures of the first abutting part 21b and the second abutting part 21c are the same, and the materials of the wheel body part 21 and the first abutting part 21b are the same. The material of the first abutting part 21b is different from that of the second abutting part 21c.

Referring to FIG. 6, in an implementation mode, a protective plate 23 is provided between the transmission gear 32 and the output wheel 21. The protective plate 23 is configured to protect the output wheel 21, so that when the sector gear 31 drive the transmission gear 32 to rotate, the sector gear 31 can only contact with the protective plate 23 and rub against the protective plate 23, and cannot cause friction against the output wheel 21, thereby improving the service life of the output wheel 21 and making the unidirectional drive structure 2 and the pedal driving structure 3 to be more compatible. Furthermore, a spacing between the sector gear 31 and the output wheel 21 can be set more tightly, thereby reducing the overall thickness of the starter. When the protective plate 23 is provided between the transmission gear 32 and the output wheel 21, the connection rod 2121 passes through the protective plate 23 to achieve a connection between the transmission gear 32, the protective plate 23, and the output wheel 21. It should be understood that the material of the protective plate 23 is different from that of the output wheel 21, and the material of the protective plate 23 is also different from that of the transmission gear 32. The protective plate 23 has good wear resistance.

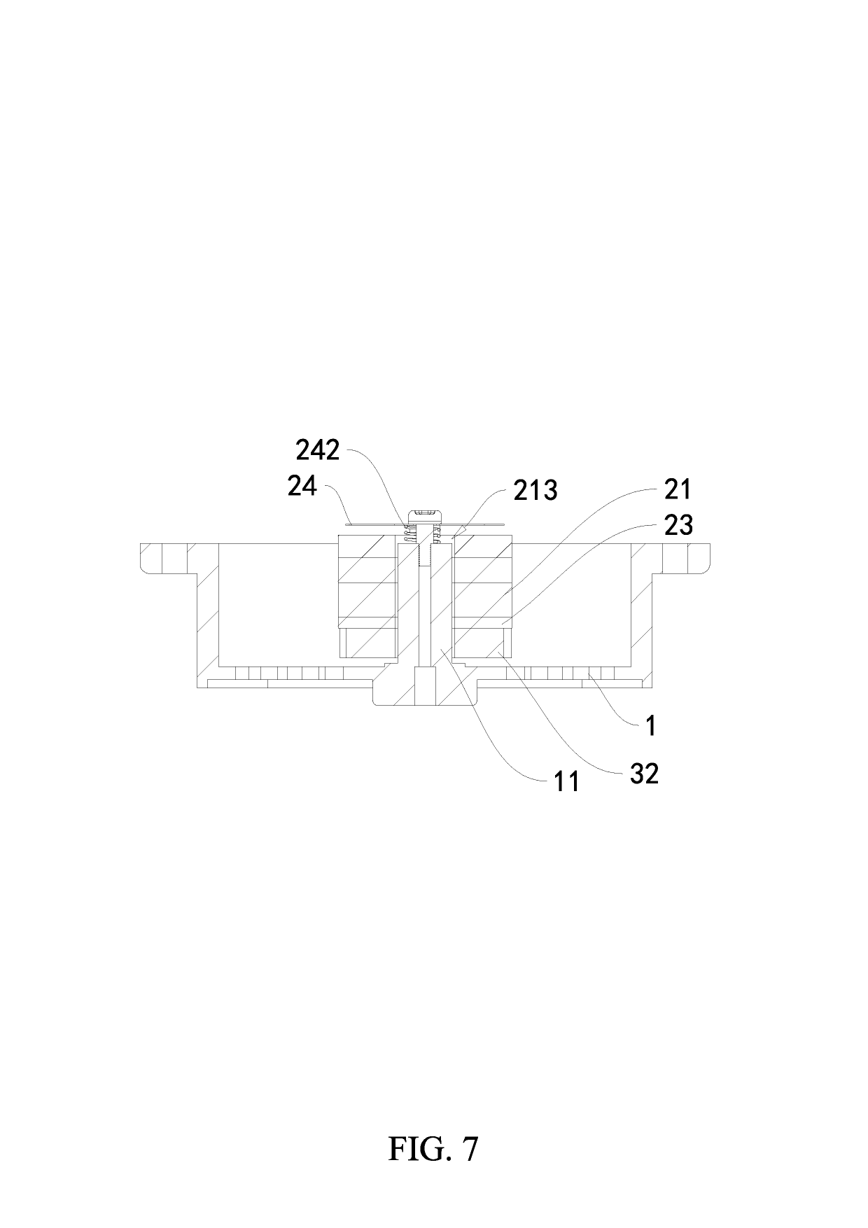

Referring to FIG. 7, in the embodiment of the present application, the shell 1 is fixedly provided with a rotating shaft 11, and the output wheel 21 is provided with a rotating hole 213. The rotating hole 213 extends from the output wheel 21 to the transmission gear 32. The rotating shaft 11 is penetrated through the rotating hole 213 and rotates and cooperates with the rotating hole 213, so that the transmission gear 32 and the output wheel 21 are rotatably provided in the shell 1.

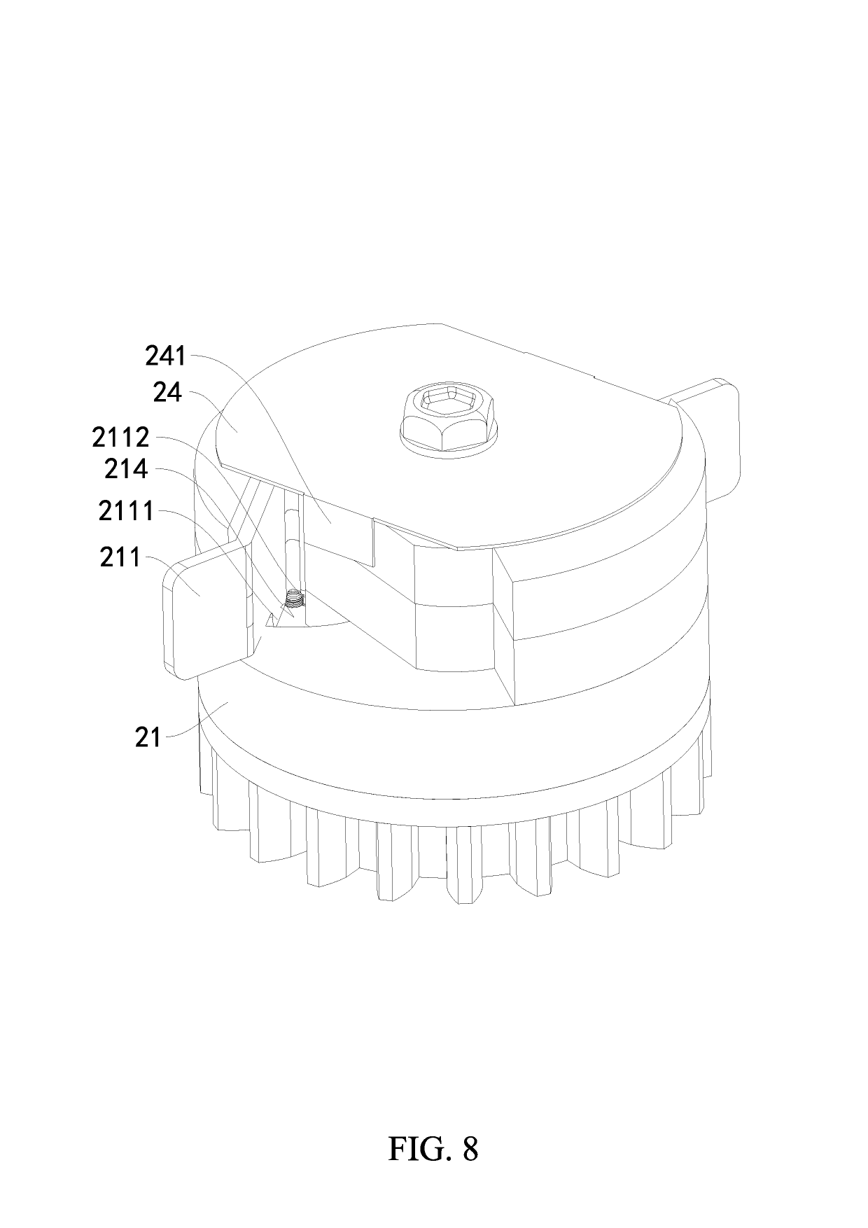

Referring to FIG. 8, in the embodiment of the present application, the unidirectional drive structure 2 further includes an opening plate 24, and the opening plate 24 is rotatably provided on the shell 1. The opening plate 24 is provided with an opening protrusion 241. When the output wheel 21 rotates in the forward direction, the opening protrusion 241 pushes the output claw 211 to open in a direction away from the output wheel 21. Specifically, the opening plate 24 is provided with a through hole, and a bolt passes through the hole of the opening plate 24 and is threaded with the rotating shaft 11, so that the opening plate 24 is rotatably provided on the shell 1. It should be understood that the frictional resistance that needs to be overcome when driving the opening plate 24 to rotate is greater than the frictional resistance that needs to be overcome when driving the output wheel 21 to rotate, so that the output wheel 21 rotates, and the opening plate 24 is rotated driven by a contact between the opening protrusion 241 and the output claw 211. The opening protrusion 241 can push the output claw 211 to open in a direction away from the output wheel 21, until the output claw 211 and the output wheel 21 rotate; in an implementation mode, an opening spring 242 is provided between the opening plate 24 and the output wheel 21. One end of the opening spring 242 is in contact with the opening plate 24, and the other end of the opening spring 242 is in contact with the output wheel 21.

Referring to FIG. 8, in an implementation mode, the output claw 211 is fixedly provided with a connection protrusion 2111, and the output wheel 21 is provided with a connection recess 214. The connection protrusion 2111 is penetrated the connection recess 214, and the output claw 211 abuts against the opening plate 24 to achieve a connection between the output claw 211 and the output wheel 21. It should be understood that when the connection protrusion is penetrated the connection recess 214, the connection recess 214 cannot interfere with the output claw 211 that is opened away from the output wheel 21 or is closed towards a direction of the output wheel.

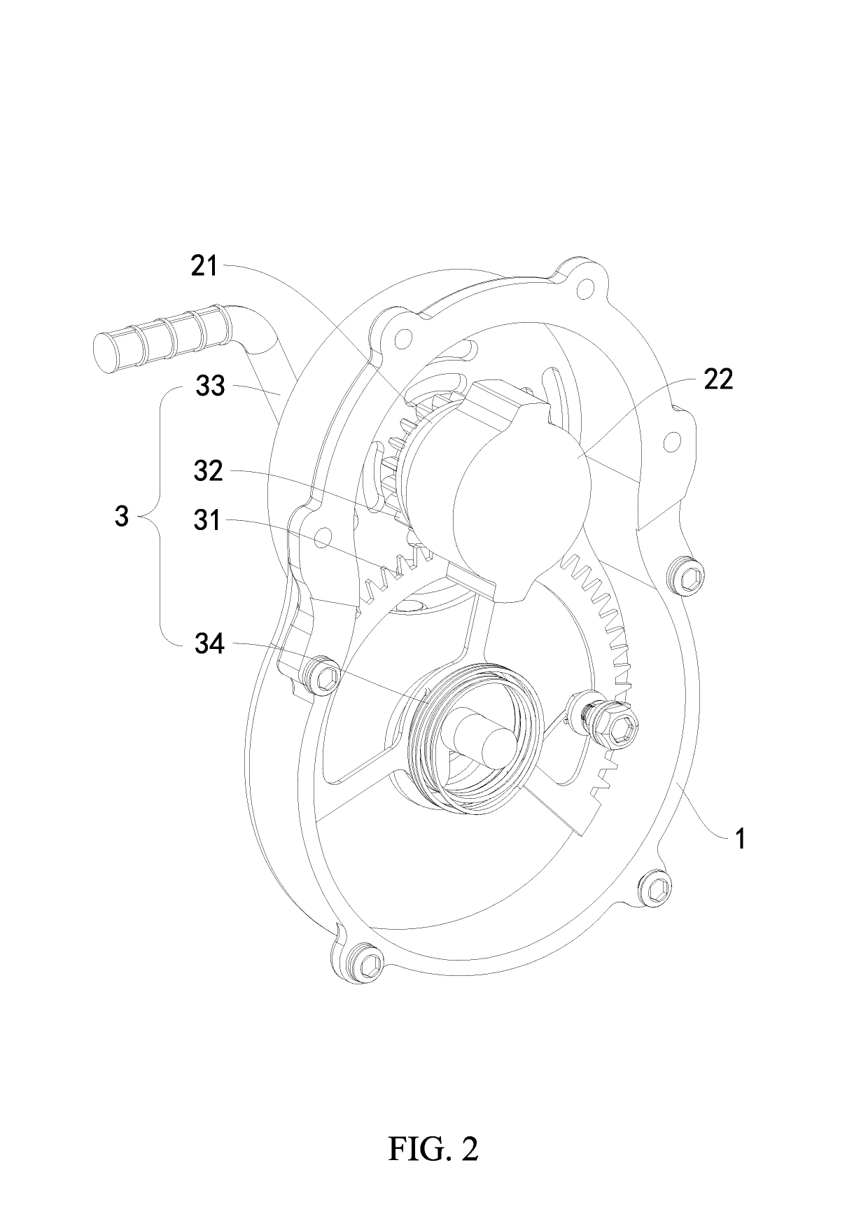

Referring to FIG. 2, in an implementation mode, an output torsion spring 2112 is provided between the output claw 211 and the output wheel 21. The output torsion spring 2112 is configured to push the output claw 211 to close in a direction close to the output wheel 21, so that on the basis of the input wheel 22 pushing the output claw 211 to close in a direction close to the output wheel 21, the output torsion spring 2112 assists in pushing the output claw 211 to close in a direction that is close to the output wheel, so that when the output wheel 21 rotates in an opposite direction, the output claw 211 can quickly switch from open to closed, thereby cutting off the power transmission between the output wheel 21 and the input wheel 22 more quickly.

In the embodiment of the present application, the pedal driving structure 3 further includes a reset torsion spring 34, one end of the reset torsion spring 34 is connected to the sector gear 31, and the other end of the reset torsion spring 34 is connected to the shell 1, so that after the user quickly steps on the footstock lever 33, the reset torsion spring 34 can push the sector gear 31 to reset, thereby facilitating the user’s next step on the footstock lever 33.

In the present embodiment, the footstock lever 33 includes a fixed portion 331 and a lever body 332. The fixed portion 331 is connected to the sector gear 31, and the lever body 332 is rotatably connected to the fixed portion 331.

The implementation principle of the engine starter in this application is as follows: when the engine needs to be started, the user quickly steps on the footstock lever 33, and the footstock lever 33 drives the sector gear 31 to rotate, and the sector gear 31 drives the transmission gear 32 to rotate. The transmission gear 32 drives the output wheel 21 to rotate in the forward direction, so that the output claw 211 opens in the direction away from the output wheel 21 and passes through the input slot 221 to drive the input wheel 22 to rotate, so that the input wheel 22 drives the crankshaft of the engine to rotate, thereby achieving the start of the engine. By quickly stepping on the footstock lever 33 to drive the engine, it can better meet the user’s starting needs when the engine is used as a power source for cars and other vehicles, thereby enabling the starter to better meet the user’s starting needs for the engine, improving the problem that the starter drives the engine to rotate by quickly pulling the rope, which is difficult to meet the user’s starting needs for the engine. Furthermore, when the engine is started, the output wheel 21 rotates in the opposite direction, and the output claw 211 closes and disengages from the input slot 221 in the direction that is close to the output wheel 21, thereby achieving one-way power transmission between the output wheel 21 and the input wheel 22.

The above are the preferred embodiments of the present application and do not limit the protection scope of the present application. Therefore, any equivalent changes made according to the structure, shape, and principle of the present application should be included in the protection scope of the present application.

What is claimed is:

1. An engine starter, comprising:
a shell;
a unidirectional drive structure, which comprises an output wheel and an input wheel, wherein the output wheel is rotatably provided on the shell, the input wheel is connected to a crankshaft of an engine, the output wheel is connected to an output claw, the input wheel is provided with an input slot, and the output wheel has forward and reverse rotation; when the output wheel rotates in a forward direction, the output claw is opened in a direction away from the output wheel and penetrates the input slot to drive the input wheel to rotate; when the output wheel rotates in a reverse direction, the output claw is closed in a direction close to the output wheel and disengages from the input slot; and
a pedal driving structure, which comprises sector gear, a transmission gear, and a footstock lever; the sector gear are rotatably provided on the shell, and the transmission gear is rotatably provided on the shell and connected to the output wheel; the sector gear meshes with the transmission gear, and the footstock lever and sector gear are connected and configured to drive the sector gear to rotate.

2. The engine starter according to claim 1, wherein the output wheel is provided with a connection hole, the connection hole extends from the output wheel to the transmission gear, and the connection hole is provided with a connection rod to achieve a connection between the transmission gear and the output wheel.

3. The engine starter according to claim 2, wherein the output wheel comprises a wheel body part, a first abutting part, and a second abutting part, the wheel body part and the first abutting part are integrally formed, and the second abutting part is connected to the first abutting part;
when the connection rod is provided in the connection hole, the connection rod sequentially connects the wheel body part, the first abutting part, and the second abutting part to achieve a connection between the first abutting part and the second abutting part.

4. The engine starter according to claim 2, wherein a protective plate is provided between the transmission gear and the output wheel, the protective plate is configured to protect the output wheel, and when the protective plate is provided between the transmission gear and the output wheel, the connection rod passes through the protective plate to achieve a connection between the transmission gear, the protective plate, and the output wheel.

5. The engine starter according to claim 1, wherein the unidirectional drive structure further comprises an opening plate, and the opening plate is rotatably provided on the shell,
the opening plate is provided with an opening protrusion;
when the output wheel rotates in the forward direction, the opening protrusion pushes the output claw to open in a direction away from the output wheel.

6. The engine starter according to claim 5, wherein an opening spring is provided between the opening plate and the output wheel, one end of the opening spring is in contact with the opening plate, and the other end of the opening spring is in contact with the output wheel.

7. The engine starter according to claim 5, wherein the output claw is fixedly provided with a connection protrusion, the output wheel is provided with a connection recess, the connection protrusion is penetrated through the connection recess, and the output claw abuts against the opening plate to achieve a connection between the output claw and the output wheel.

8. The engine starter according to claim 7, wherein an output torsion spring is provided between the output claw and the output wheel, and the output torsion spring is configured to push the output claw to close in a direction close to the output wheel.

9. The engine starter according to claim 1, wherein the pedal driving structure further comprises a reset torsion spring, one end of the reset torsion spring is connected to the sector gear, and the other end of reset torsion spring is connected to the shell.

10. The engine starter according to claim 1, wherein the footstock lever comprises a fixed portion and a lever body, the fixed portion is connected to the sector gear, and the lever body is rotatably connected to the fixed portion.
